(19) United States
(12) Patent Application Publication
(10) Pub. No.: US 2005/0237209 A1
(43) Pub. Date: Oct. 27, 2005

(54) Posture detector

(76) Inventor: Christophe Van Dongen, La Chaux-de-Fonds (CH)

Correspondence Address: VAN TASSEL AND ASSOCIATES, POST OFFICE BOX 2928, BELLAIRE, TX, 77402-2928, US

(21) Appl. No.: 10/518,744

(22) PCT Filed: May 27, 2003
(86) PCT No.: PCT/CH03/00332

§ 371 Date: May 25, 2005

(30) Foreign Application Priority Data
Jun. 7, 2002 (EP) 02405460.3

(51) Int. Cl. G08B 23/00

(52) U.S. Cl. 340/573.7

(57) ABSTRACT

The invention relates to a device (10) to be applied to a person in order to detect the incorrect postures thereof, i.e. at-risk postures. Said device is placed on the sternum and comprises an inclinometer (26) which supplies a signal representing the angle of inclination of the sternum relative to a vertical line, a calculator (28) which receives said signal and is programmed so as to cyclically execute the following operations: measure the angle of inclination; compare said measurement with two stored threshold values of said angle, which respectively correspond to forward-leaning and backward-leaning positions that constitute a pathological risk for the person; and produce an indication of the threshold values being exceeded. The inventive device also comprises signaling means which respond to said indication in order to inform the person and/or the therapist.

The present invention concerns a device to be applied to a person for detecting and storing certain postures such as exaggerated bending and extension of the trunk.

This enables this person to improve his posture awareness and thus prevent one of the main causes of back pain: exaggerated forward and backward movements of the trunk in the standing position. Backache is one of the major pathologies of our society. The sedentary way of life leads to a loss of our (proper) kinesthetic sense, which no longer allows us accurately to feel physiologically permitted postures. As regards the back, it is estimated that, during a lifetime, 80% of the population experience a back malfunction and pain. The discomfort and expenses occasioned by such dorsalgia are worrying and require more than ever a preventative policy reinforced by technical means.

Several solutions have already been disclosed for helping back-sufferers to correct incorrect posture.

For example, WO Patent No. 96/17548 refers to a case applied to the vertebrae of the user's spinal column. When the user bends over, the pressure exerted by the vertebrae on the support zones of the device press a kind of switch and thus set off an alarm. The zones concerned are thus obviously restrained and the movements of ordinary life quickly shift the case, which is then no longer efficient.

WO Patent No. 90/07360 discloses an apparatus, one face of which is for applying against the body. One part of this face is cut to form a control plate. When the plate is pressed beyond a determined threshold, it triggers a vibration generator forming a tactile warning device. Adjustment of the trigger threshold is however difficult and does not correspond accurately to determined positions.

WO Patent No. 91/06082 mentions a strip that is bent and pressed against the lumbar curve of the user and returning to a rest position when an improper posture is adopted. It then plays the part of a switch and actuates a vibro-tactile warning device. This method suffers, however, from a basic drawback: it restricts lumbar mobility, necessary for the life of the intervetebral discs.

The present invention proposes an inexpensive device, capable of indicating a user's incorrect posture, the detection threshold being able to be defined with precision by a therapist. Moreover, installing and using the device does not in any way interfere with the daily movements of a normal user.

More specifically, the invention concerns a device to be applied to a person in order to detect the incorrect posture thereof, i.e. postures with a pathological risk, characterized in that it is placed on a segment of the body and includes:
an inclinometer supplying a signal representative of the angle of inclination of this segment with respect to a vertical line,
a calculator receiving said signal and programmed to execute cyclically the operations of:
   obtaining a measurement of the angle of inclination,
   comparing this measurement to two stored threshold values of said angle, respectively corresponding to leaning positions in a first direction and an opposite direction, which constitute at-risk postures, and
   generating an indication of breaches of the threshold values, and
indicating means, responding to said indication, to inform the person and/or the therapist.

Advantageously, the inclinometer used is an accelerometer.

Furthermore, the device includes an interface for storing, by using push-buttons, the two threshold values of the angle of inclination in the calculator.

According to the invention, the indicating means advantageously include, on the one hand, a light and/or acoustic and/or vibrating alarm and, on the other hand, a memory that can be read from the exterior including a plurality of registers assigned to successive time slots regrouping a plurality of cycles, the calculator being then programmed to count, in each of said registers, either the breaches of the forward and backward threshold values observed at each of the cycles of the current time slot, or the maximum value of the breaches of the forward and backward threshold values observed during said time slot.

Typically said cycles and said time slots have a respective duration of 100 ms and 15 minutes.

The invention will be better understood in light of the following description, made with reference to the annexed drawing, in which:

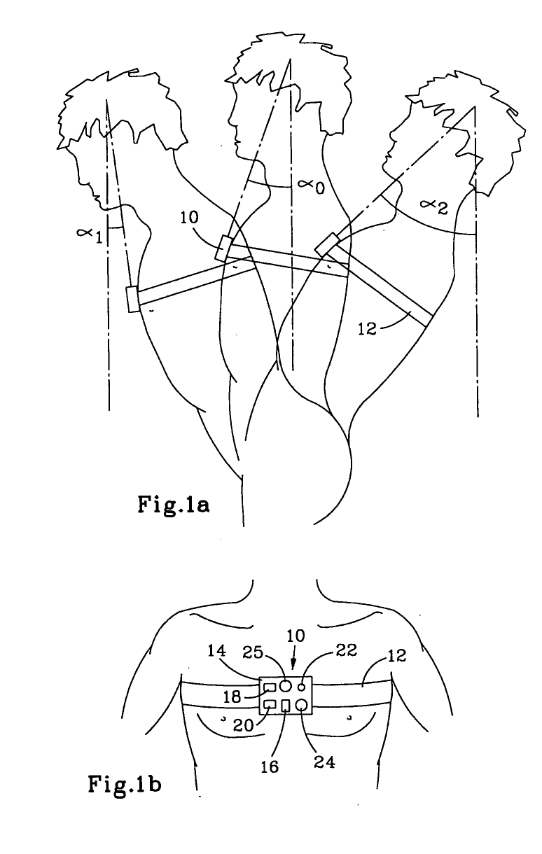

FIG. 1 is, at a, a profile view, and at b, a front view of a person fitted with the device according to the invention and occupying different characteristic postures;

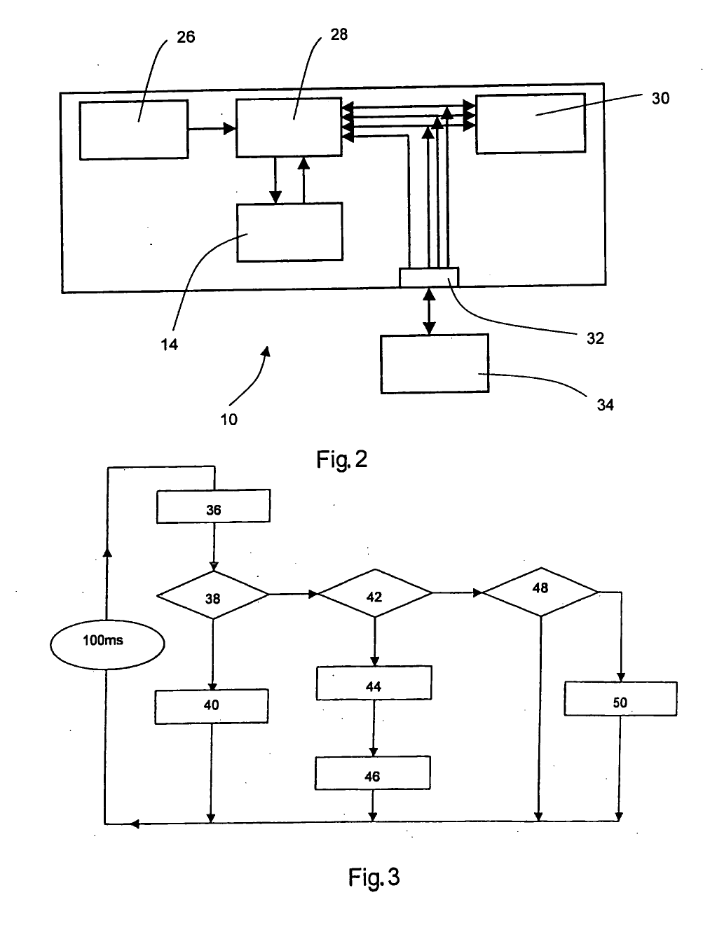

FIG. 2 is a flow chart of the device; and

FIG. 3 is a logic diagram summarizing the operating principle of the device.

FIGS. 1a and 1b show, at 10, the device according to the invention, installed on a user's sternum. It is held in place by a thoracic belt 12 made by means of an elasticated band whose length can be adjusted by a buckle.

It can be seen in FIG. 1b that the case of the device includes an interface 14 including:
a switch 16 for switching the apparatus on or off,
two push-buttons 18 and 20, via which the incorrect posture detection thresholds can be programmed and different modes of use can be selected, and
a light emitting diode (LED) 22, an acoustic alarm (buzzer) 24 and a vibrator 25 which can warn the user if an incorrect posture is detected.

FIG. 1a is a profile view of the user in various positions. The angle that device 10 makes with a vertical line, when it is applied against the sternum, will be called a.

At the center, the user is standing upright, heels, buttocks, shoulder blades and head pressing against a vertical line, which is a reference position for the trunk. Then angle α then has the reference value α₀.

When the user leans forwards, the therapist determines the forward threshold, corresponding to an angle α₁, which, if repeatedly exceeded, would be damaging over time.

Likewise, when the user leans backwards, the therapist determines the backward threshold, corresponding to an angle α₂, which, if repeatedly exceeded would also be damaging over time.

As shown in FIG. 2, device 10 essentially includes an inclinometer 26 supplying a signal representative of the angle of inclination α, a microprocessor 28 for receiving and processing said signal, an EEPROM type memory 30 associated with the microprocessor, the aforementioned interface 14, and a connector 32 for connecting the microprocessor and the memory to a computer 34.

The inclinometer 26 is, in fact, an accelerometer, like that marketed under the reference ADXL202EB by the firm Analog Device. It generates a voltage proportional to the sinus of angle of inclination α. The microprocessor is, for example, Microchip model PIC16F873 clocked at 32 kHz.

In order to use the device according to the invention, its microprocessor 28 must previously have stored threshold angles α₁ and α₂.

The operation can be carried out at a therapist's, who invites the person to lean forwards or backwards as far as the position that the therapist considers to be the threshold. At that moment, the therapist only needs to simultaneously press the two buttons 18 and 20 then, for example, press button 18 or button 20 for angle α₁ or angle α₂ respectively to be stored in microprocessor 28. Since this technique is well known to those skilled in the art for numerous fields of application, it will not be described in detail here.

The sequence of operations executed by microprocessor 28 when device 10, with angles α₁ and α₂ stored in its memory, is switched on, on the person's sternum, will now be described.

Microprocessor 28 is programmed to observe the behavior of the user in 15 minute time slots and, inside each time slot, to execute cyclically the operations shown in FIG. 3. Typically, the duration of the cycles is 100 ms.

The first operation 36 is to measure of the angle α from the signal delivered by inclinometer 26.

Then, the system determines, at 38, whether α is less than α₁ or greater than α₂.

If this is not the case, this means that the user has not exceeded any of the fixed thresholds. The next operation is, then, at 40, to switch off warning devices 22 and/or 24 and/or 25 which, if they have been switched since from the preceding cycle, cease their activity. The cycle then ends.

When, conversely, the system has detected that α is less than α₁ or greater than α₂, this means that the user has exceeded the forward or backward threshold. The next operation is, then, at 42, to check whether this breach has been accounted for.

If this is not the case, this means that the breach has just occurred. The system thus increments by one unit, at 44, the register of memory 30 assigned to counting, for the current 15 minute time slot, and depending upon the particular case, breaches of the forward or backward threshold. The next operation is, then, at 46, to switch on warning devices 22 and/or 24 and/or 25 which indicate a posture error to the user. The cycle then ends.

When, conversely, it has been observed, at 42, that the detected breach has already been stored, this means that the user is still occupying, since at least the preceding cycle, a position exceeding the fixed thresholds and that the warning devices are still active. In such case, the system checks, at 48, whether the breach has lasted more than five seconds.

If this is the case, this means that the user is in a stable posture (because, for example, he is tying his shoelaces, . . . ) and that it is thus unnecessary to bother him further by leaving the warning devices in action. The system then switches off the warning devices, at 50, and the cycle ends.

In a variant, one could provide that, in such case, the warning devices are not stopped, but conversely, the signals emitted are increasingly amplified.

When, however, it is observed that the breach has lasted less than five seconds, this means that it is useful to leave the warning devices in constant action. The cycle thus ends, without switching them off.

The device according to the invention, as it has just been described, can remain on the person for several days (except at night when the apparatus is paused) and can thus store, every 15 minutes, the number of breaches, forwards or backwards, of the posture thresholds fixed by the therapist.

When the person returns the device to the therapist, the latter connects it to computer 34, which can provide, in the form of a table or graph, the number of breaches of the forward or backward thresholds, that have occurred in 15 minute time slots during the entire observation period, with, in addition, the pauses. This histogram is very useful for specifying the etiology of the affection and teaching which preventative measures can be envisaged.

As a variant, the system could provide the maximum value of the breaches of the forward and backward threshold values, for each reference time slot.

According to another variant, it is possible to program the microprocessor such that the user is warned when he is approaching, typically at less than four degrees, the forward and backward thresholds. In such case, the warning devices emit a different signal (for example, weaker) than that emitted in the event of a breach.

It will also be noted that it is useful, for the user and the therapist, to be able to deactivate the warning devices while keeping the storage system active. This can be accomplished by a prolonged application of pressure on button 16, which deactivates them, and by a prolonged application of pressure on the other button 18, which reactivates them.

This description has been given by way of non-limiting example and the device can also be installed on other parts of the body, for example an arm or a leg, in certain particular therapeutic conditions. Evidently, the invention can be adapted to monitor the patient's inclination, when he leans from one side or the other. Advantageously, two inclinometers can be combined to warn the patient of a breach of threshold positions defined in all four directions.

Finally, the histogram will give evidence as to the actual use of the apparatus by the user. Indeed, in a variant, one could envisage the memory, of a larger size, storing not only the number of breaches, but also all the angle values at a determined frequency, which will enable one to detect whether the apparatus has been put down without the pause function being activated.

1. Device to be applied to a person in order to detect the incorrect postures thereof, i.e., at-risk postures, characterized in that it is placed on a segment of the body, and includes:
an inclinometer (26) delivering a signal representative of the angle of inclination of said segment with respect to a vertical line,
a calculator (28) receiving said signal and programmed to execute cyclically the operations of:
obtaining a measurement of the angle of inclination (36),
comparing this measurement to two stored threshold values of said angle, respectively corresponding to leaning positions in a first direction and a second opposite direction, which constitute at-risk postures (38), and
generating an indication of breaches of the threshold values (46), and
indicating means, responding to said indication, to inform the person and/or the therapist.

2. Device according to claim 1, characterized in that said inclinometer (26) is an accelerometer.

3. Device according to claim 1, characterized in that it further includes an interface (14) for storing, using push-buttons (18, 20), the two threshold values of the angle of inclination in the calculator (28).

4. Device according to claim 1, characterized in that said indicating means including a light alarm (22).

5. Device according to claim 1, characterized in that said indicating means include an acoustic alarm (24).

6. Device according to claim 1, characterized in that said indicating means include a vibrating alarm (25).

7. Device according to claim 1, characterized in that said indicating means include a memory (30) that can be read from the exterior, including a plurality of registers assigned to successive time slots regrouping a plurality of cycles, and in that said calculator (28) is programmed to store, in each of said registers, breaches of the forward and backward threshold values observed at each of the cycles of the current time slot.

8. Device according to claim 1, characterized in that said indicating means include a memory (3) that can be read from the exterior, including a plurality of registers assigned to successive time slots regrouping a plurality of cycles, and in that said calculator (28) is programmed to record, in each of said registers, the maximum value of breaches of the forward and backward threshold values observed during the current time slot.

9. Device according to claim 7, characterized in that said cycles and said time slots have a respective duration of 100 ms and 15 minutes.

10. Device according to claim 1, characterized in that said positions are forward or backward leaning positions.

11. Device according to claim 4, characterized in that said indicating means include an acoustic alarm (24).

12. Device according to claim 4, characterized in that said indicating means include a vibrating alarm (25).

13. Device according to claim 5, characterized in that said indicating means include a vibrating alarm (25).

14. Device according to claim 4, characterized in that said indicating means include a memory (30) that can be read from the exterior, including a plurality of registers assigned to successive time slots regrouping a plurality of cycles, and in that said calculator (28) is programmed to store, in each of said registers, breaches of the forward and backward threshold values observed at each of the cycles of the current time slot.

15. Device according to claim 5, characterized in that said indicating means include a memory (30) that can be read from the exterior, including a plurality of registers assigned to successive time slots regrouping a plurality of cycles, and in that said calculator (28) is programmed to store, in each of said registers, breaches of the forward and backward threshold values observed at each of the cycles of the current time slot.

16. Device according to claim 6, characterized in that said indicating means include a memory (30) that can be read from the exterior, including a plurality of registers assigned to successive time slots regrouping a plurality of cycles, and in that said calculator (28) is programmed to store, in each of said registers, breaches of the forward and backward threshold values observed at each of the cycles of the current time slot.

17. Device according to claim 8, characterized in that said cycles and said time slots have a respective duration of 100 ms and 15 minutes.

18. Device according to claim 2, characterized in that said positions are forward or backward leaning positions.

19. Device according to claim 3, characterized in that said positions are forward or backward leaning positions.

20. Device according to claim 4, characterized in that said positions are forward or backward leaning positions.
